(19) United States
(12) Patent Application Publication
(10) Pub. No.: US 2010/0075174 A1
(43) Pub. Date: Mar. 25, 2010

(54) Method for deposition of chromium layers as hard-chrome plating, electroplating bath and hard-chrome surfaces

(75) Inventors: Jens Bohnet, Lossburg (DE); Martin Metzner, Gschwend (DE); Herwig Krassnitzer, Althofen (AT); Karl Schermanz, Launsdorf (AT)

Correspondence Address: MILLEN, WHITE, ZELANO & BRANIGAN, P.C., 2200 CLARENDON BLVD., SUITE 1400, ARLINGTON, VA, 22201, US

(73) Assignee: Fraunhofer-Gesellschaft zur Forderung der angewandten Forschung e.V., Munchen (DE)

(21) Appl. No.: 12/375,907

(22) PCT Filed: Jul. 31, 2007
(86) PCT No.: PCT/EP2007/006783

§ 371 Date: Nov. 27, 2009

(30) Foreign Application Priority Data
Aug. 1, 2006 (DE) 10 2006 035 871.6

(51) Int. Cl. B32B 15/00; C25D 3/10; C25D 3/04

(52) U.S. Cl. 428/666; 205/82; 205/283; 205/290; 205/284

(57) ABSTRACT

The invention relates to a method for deposition of chromium layers as hard-chrome plating for protection against wear or corrosion and/or for decorative purposes and also an electroplating bath with which chromium layers of this type can be deposited. The invention also relates to hard-chrome surfaces produced accordingly.

### FIELD OF THE INVENTION

The invention relates to a method for deposition of chromium layers as hard-chrome plating for protection against wear or corrosion and/or for decorative purposes and also an electroplating bath with which chromium layers of this type can be deposited. The invention also relates to hard-chrome surfaces produced accordingly.

### DESCRIPTION OF PRIOR ART

In the case of commercial methods which have become known to date from prior art for producing thick chromium coatings, electrolytes in which the chromium to be deposited is present in a hexavalent form are used virtually exclusively.

Efforts have been made since the beginning of electrolytic chromium deposition to replace the toxic chromium(VI) electrolytes by chromium(III) electrolytes. The attempt to replace the chromium(VI) compounds by chromium(III) compounds starts from the fact that chromium(VI) compounds which pass into the body can lead to serious health problems. In addition to health and environmentally endangering aspects, also high costs arise for disposal of chromium(VI)-polluted waste waters.

In general, a distinction must be made between the deposition of decorative, thin (<3 μm) chromium layers for glossy chroming, obtaining metallic chromium from chromium(III)-containing solutions and the deposition of thick (>5 μm) chromium layers as wear- and corrosion protection layers.

There are already numerous methods and patents for decorative chrome plating which deal with this topic. These methods produce a thin high-gloss chromium layer. For layer thicknesses above 5 μm, these methods are however only suitable in a restricted manner.

In the last few years, there have been numerous attempts to replace industrial chroming from chromium(VI)-containing processes by processes based on chromium(III).

An electroplating bath for the deposition of chromium layers is known from GB 1 602 404 which is based on chromium(III). In this case, the separation between catholyte and anolyte is effected by means of a cation exchanger membrane. Anions for reducing the deposition voltage are added here to the catholyte, as a result of which an increase in the voltage during the electroplating can be avoided.

However there has been no success to date in developing a method by means of which the widespread hard-chrome plating from chromium(VI)-containing electrolytes was able to be replaced in commercial use. This can be attributed to the following points:
1. The chromium layers deposited from the previously known methods do not correspond to the requirements known for hard-chroming with respect to a layer thickness of 5 μm and above.
2. The hardness of the layers which can be deposited from these baths does not achieve the required layer hardnesses of at least 800 HV and above.
3. The known baths, with respect to reproducibility of the layers which can be deposited, do not deliver the qualities known from chromium(VI)-containing electrolytes. The chromium layers are very fissured from layer thicknesses of >5 μm and detach from the underlying material.

These restrictions of the already known chroming electrolytes based on chromium(III) result from the rapidly changing pH value due to the reaction at the cathode and the oxidation of chromium(III) to chromium(VI) at the anode. Already known developments provide a separation of the anode and cathode space by a diaphragm or a cation exchanger membrane. The oxidation of chromium(III) ions at the anode is prevented by this membrane. The transport of the electrical current is ensured by H⁺ ions. This transport serves simultaneously for equalising the pH value which increases as a result of the hydrogen produced in the catholyte space.

Because of the jointly deposited chromium and the cationic salt radicals remaining in the catholyte, the result in the catholyte is a reduction in pH value which must be compensated for by the addition of a base, such as for example ammonia. The addition of ammonia leads as a rule to a locally greatly increasing pH value in the electrolyte, chromium hydroxide which is difficult to dissolve then being precipitated.

### SUMMARY OF THE INVENTION

Starting herefrom, it was the object of the present invention to provide a method with which reproducible deposition of chromium layers is made possible, which layers have a thickness which is sufficient for corrosion- or wear protection and have great hardness. The method is thereby intended to have a wide field of application and to be suitable in principle also for deposition of decorative layers.

This object is achieved by the method having the features of claim 1, the electroplating bath having the features of claim 13 and the hard-chrome surfaces having the features of claim 26. The further dependent claims reveal advantageous developments.

### DETAILED DESCRIPTION OF THE INVENTION

According to the invention, a method is provided for deposition of chromium layers as hard-chrome plating for protection against wear or corrosion and/or as decorative chrome plating. The method is based on a part being connected as a cathode and being immersed in a catholyte comprising at least one chromium(III) salt and at least one compound stabilizing chromium(II) ions.

An anolyte comprising a Brönsted acid is used at the same time. Catholyte and anolyte are separated by an anion-selective membrane, also termed anion exchanger membrane. In the present invention, it is in addition essential that at least one measuring device is used, by means of which deviations in pH value from a predefined pH value are monitored continuously. The predefined pH value is thereby determined as a function of the chromium(III) salts which are used so that an optimal chromium deposition is effected. In addition, a control device is used in the method according to the invention by means of which the pH value can be adjusted to the preset value in that automated addition of an acid or a base is effected.

The method according to the invention is characterised by the separation of the cathode and the anode space by an anion exchanger membrane. Mixing of the anolyte with the catholyte is prevented by the anion exchanger membrane. As a result, no chromium(III) ions pass to the anode side, as a result of which oxidation of chromium(III) ions into chromium(VI) ions at the anode can be prevented. By using the anode exchanger membranes, the chromium(III) ions which are present generally as cation complexes can likewise be prevented from penetrating through the membranes. The anolyte is contaminated with chromium ions during the coating not at all or only to a slight extent. The concentration of chromium(VI) ions in the anolyte can be prevented entirely by the addition of oxalic acid as reductive type to the anolyte. The addition of substances, such as ferrocyanides, to the anolyte or of sodium thiocyanates as described in GB 1 602 404, can be dispensed with entirely.

In the description of deposition mechanisms for the chromium deposition from chromium(III)-containing electrolytes into metallic chromium layers, it is assumed that the deposition extends further to metallic chromium via the steps chromium(III) to chromium(II). Since chromium(II) is oxidised very rapidly in air to form chromium(III), this cation must be stabilised. This can be effected preferably by the addition of amino acids or by urea. However it is also likewise possible to implement the electroplating under an inert gas atmosphere in order to prevent oxidation of the chromium(II).

Since during deposition of chromium layers the result is an increase in pH value as a result of hydrogen formation at the cathode and as a result of the transport of ions through the membrane, constant conditions during the chromium deposition can only be ensured by continuous monitoring of the electroplating bath with respect to the pH value. This is effected preferably by continuous circulation of the catholyte which flows through a pH measuring cell. If an increase in pH value results, acid can then be metered subsequently into the electrolyte by the control device.

A preferred variant thereby provides that the acid is removed from the anolyte in the continuous coating process and is subsequently metered into the catholyte. It is thereby likewise possible to add the acid to the catholyte via an external acid reservoir.

In addition, it is preferred that the temperature of the electroplating bath is also controlled in addition to the pH value. With the help of a temperature measuring cell, this is monitored and can then be adjusted to the desired value by means of a cooling or heating device.

A compound from the group consisting of ammonium chromium alum, potassium chromium alum, chromium chloride, chromium sulphate is selected preferably as chromium(III) salt or mixtures thereof are used. The concentration of chromium(III) salt is thereby preferably in a range of 0.1 mol/l up to the solubility limit of the salt or salt mixture in the catholyte.

There are used as compounds which stabilise chromium(II) ions preferably amino acids, urea derivatives, aliphatic, mixed aromatic-aliphatic, cycloaliphatic or aromatic amines and/or amides. The concentration of these compounds is thereby preferably in the range of 0.5 mol/l to 3 mol/l, more preferably 0.5 mol/l to 1.2 mol/l relative to the catholyte.

A further preferred variant provides that a buffer substance for buffering the pH value of the catholyte is added to the catholyte. This is selected thereby preferably from the group consisting of the systems boric acid/borate, citric acid/citrate, aluminium³⁺/aluminium sulphate, oxalic acid/oxalate and/or tartaric acid/tartrate.

Wetting agents can likewise be added to the catholyte, which are selected preferably from the group consisting of anionic and neutral surfactants, such as for example sodium lauryl sulphate, sodium dodecyl sulphate, polyethylene glycols, diisohexylsulphosuccinate, 2-ethylhexylsulphate, diisobutylsulphosuccinate, diisoamylsulphosuccinate and/or isodecylsulphosuccinate.

According to the invention, an electroplating bath is likewise provided for deposition of chromium layers as hard-chrome plating for protection against wear or corrosion and/or as decorative chrome plating. The electroplating bath is based on a catholyte comprising at least one chromium(III) salt and at least one compound stabilizing chromium(II) ions, and also an anolyte comprising a protonic acid. Catholyte and anolyte are hereby separated by an anion-selective membrane. In addition, the electroplating bath has a measuring device for continuous monitoring of deviations in pH value from a predefined pH value and also at least one control device for adjusting the pH value to the preset value. This is hereby effected by automated addition of an acid or a base. Advantageously, the anode is a dimensionally stable anode (DSA), i.e. an anode which does not dissolve under the operating conditions. As dimensionally stable anodes according to the invention there are thereby preferred anodes which comprise graphite or a lead alloy or titanium anodes which are coated with a mixed oxide and/or platinised. Coated or platinised anodes are thereby generally formed from titanium.

According to the invention, likewise hard-chrome surfaces are provided which can be produced according to the method according to the invention. These chromium layers have a thickness of at least 5 μm, the surface having a Vickers hardness according to EN ISO 6507 of at least 800 HV. Preferably the thickness of the chromium layer is >10 μm. According to the current density, high-gloss or also matte chromium layers can be deposited. The surfaces can of course serve also for decorative purposes.

### EXAMPLES

The subject according to the invention is intended to be explained in more detail with reference to the subsequent examples without wishing to restrict the latter to the special embodiments shown here.

### Comparative Example 1

A chromium layer deposited from a

Trichrome® electrolyte by the company Atotech.

According to the specifications of the manufacturer.

Bath temperature: 30° C.
Current density: 8 A/dm²,
Deposition time: 25 minutes.

### (see FIG. 1)

### Example 1

### Coating from Ammonium Chromium Alum with Glycin

### Composition of Catholyte and Anolyte

### Catholyte:

400 g/l ammonium chromium alum, the chromium content thereby corresponding to 10.6 percent by mass.
40 g/l boric acid
80 g/l glycin
0.5 g/l sodium lauryl sulphate

### Anolyte:

30% H₂SO₄ dissolved in water

### Preparation of the Catholyte:

Ammonium chromium alum (producible according to N. Rempfer, H-W Lerner, M. Bolte, Acta Cryst. (2004), E60, i80-i81) was heated for two hours with the addition of deionised water at 80° C. After cooling the ammonium chromium alum solution to 40° C., the boric acid and the glycin were added to the electrolyte. The pH value was subsequently adjusted to a pH value of 2.25 before the first coating by the addition of ammonia. The pH measuring device used was calibrated at 40° C.

The electroplating chromium deposition took place in a coating cell in which the anolyte (30% sulphuric acid) was separated from the catholyte (ammonium chromium alum batch) by an anion-exchanging membrane. The bath temperature during deposition was 40° C.±2° C. The pH value chosen was between pH 2.2 and pH 2.3. During the test, platinised titanium was used as anode.

Cylindrical round bodies with a diameter of 1 cm and a length of 10 cm were coated. The test part was made of steel. Before the coating, the test part was cathodically degreased for 5 minutes at 60° C. in an alkaline solution and subsequently for 30 seconds at a current density of 1 A/dm², rinsed in deionised water and pickled for 30 seconds in 5% sulphuric acid directly before the coating. During the coating, the cylindrical test part was rotated at 50^{1/min}.

15 A/dm² was set as cathodic current density. During the 2 hour coating, the pH value in the catholyte was maintained at 2.25 by metering anolyte thereto (see FIG. 2).
Result: Layer thickness 52.8 μm; measured with a light microscope (Zeiss—Axioplan)
   Hardness 833 HV measured on the microhardness tester (Anton Paar—MH-T4)
   Test load 50 p, 10 s, 5 p/s
   (see FIG. 3)

### Example 2

### Coating from Ammonium Chromium Alum with Diethanolamine

Like example 1, diethanolamine was used instead of glycin

The batch of electrolyte and the sample pre-treatment corresponds to example 1. 1.1 mol/l diethanolamine is used instead of glycin as complex former.

The pH value was maintained at pH 2.3 to pH 2.5 during this test.
Result: Layer thickness 58.5 μm, measured with a light microscope (Zeiss—Axioplan)
   Hardness 855 HV measured on the microhardness tester (Anton Paar—MH-T4)
   Test load 50 p, 10 s, 5 p/s

### Example 3

### Coating from Chromium Sulphate

Test like example 1, instead of the ammonium chromium alum, chromium(3) sulphate with a concentration of 40 g Cr/l was used
Result: Layer thickness 39.8 μm; measured with a light microscope (Zeiss—Axioplan)
   Hardness 901 HV measured on the microhardness tester (Anton Paar—MH-T4)
   Test load 50 p, 10 s, 5 p/s
   (see FIG. 5)

### Example 4

### Coating from Chromium Chloride

### Catholyte:

1 mol/l chromium chloride
40 g/l aluminium sulphate
80 g/l glycin
0.5 g/l sodium lauryl sulphate

### Anolyte:

30% H₂SO₄ dissolved in water

The batch of electrolyte and the sample pre-treatment corresponds to the method according to claim 1.

Aluminium sulphate instead of boric acid is used as buffer substance.

Sodium lauryl sulphate is added in addition as wetting agent to the catholyte.
Result: Layer thickness 10.8 μm; measured with a light microscope (Zeiss—Axioplan)
   Hardness 862 HV measured on the microhardness tester (Anton Paar—MH-T4)
   Test load 50 p, 10 s, 5 p/s.
   (see FIG. 6)

### Example 5

### Coating from Ammonium Chromium Alum with Urea

Like example 1, urea was used instead of glycin

The batch of electrolyte and the sample pre-treatment corresponds to example 1. 2 mol/l urea is used instead of glycin as complex former.

The pH value was maintained at pH 2.3 to pH 2.5 during this test.
Result: Layer thickness 28 μm, measured with a light microscope (Zeiss—Axioplan)
   Hardness 780 HV measured on the microhardness tester (Anton Paar—MH-T4)
   Test load 50 p, 10 s, 5 p/s
   (s. FIG. 7)

### Example 6

### Coating from Ammonium Chromium Alum with Alanine

Like example 1, alanine was used instead of glycin

The batch of electrolyte and the sample pre-treatment corresponds to example 1. 1 mol/l alanine is used instead of glycin as complex former.

The pH value was maintained at pH 2.3 to pH 2.5 during this test.
Result: Layer thickness 59.5 μm, measured with a light microscope (Zeiss—Axioplan)
   Hardness 760 HV measured on the microhardness tester (Anton Paar—MH-T4)
   Test load 50 p, 10 s, 5 p/s
   (s. FIG. 8)

### BRIEF DESCRIPTION OF THE DRAWINGS

FIG. 1: Chromium layer from a conventional chromium(III) electrolyte

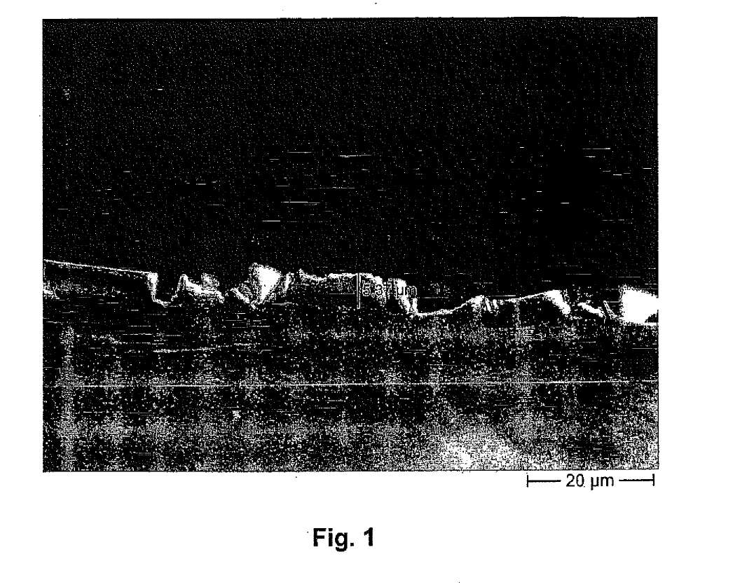

FIG. 2: Diagram of the test plant

FIG. 3: Sample from glycine bath

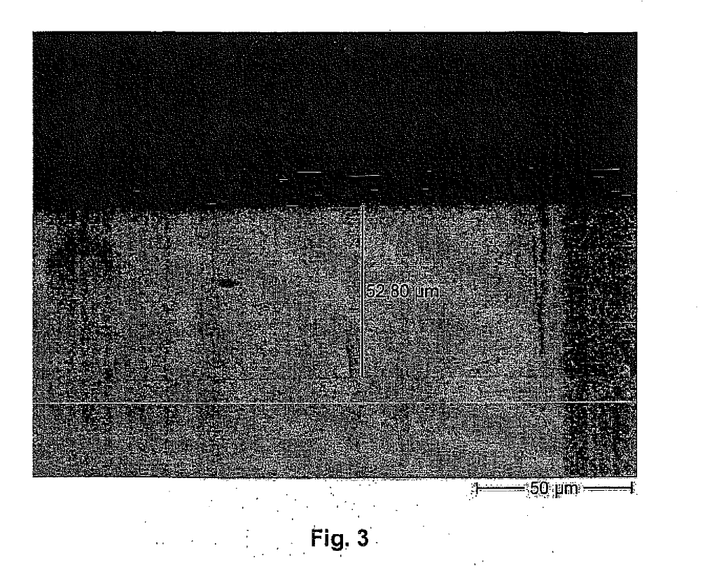

FIG. 4: Sample from diethanolamine electrolyte

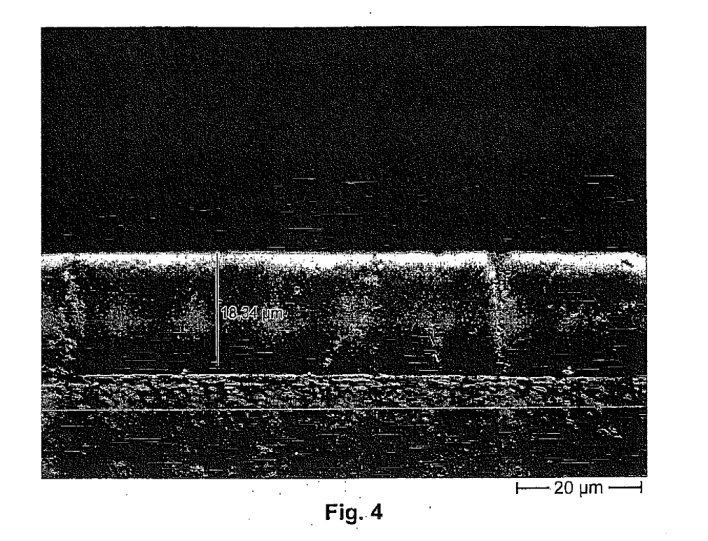

FIG. 5: Sample from glycine chromium sulphate electrolyte

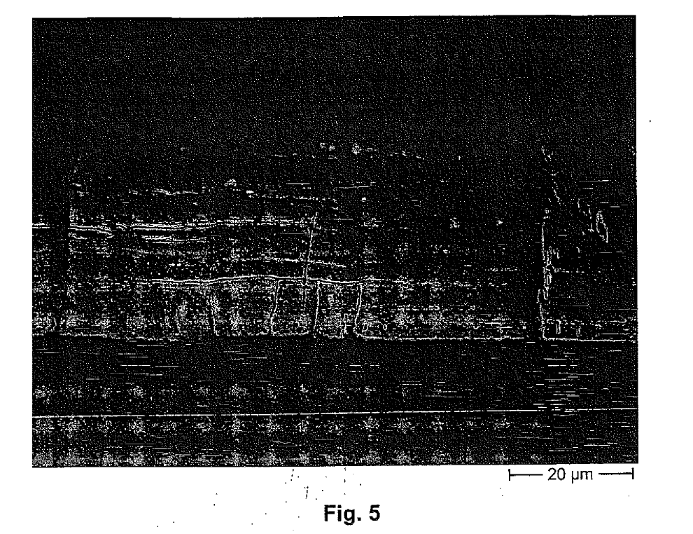

FIG. 6: Sample from glycine chromium chloride electrolyte

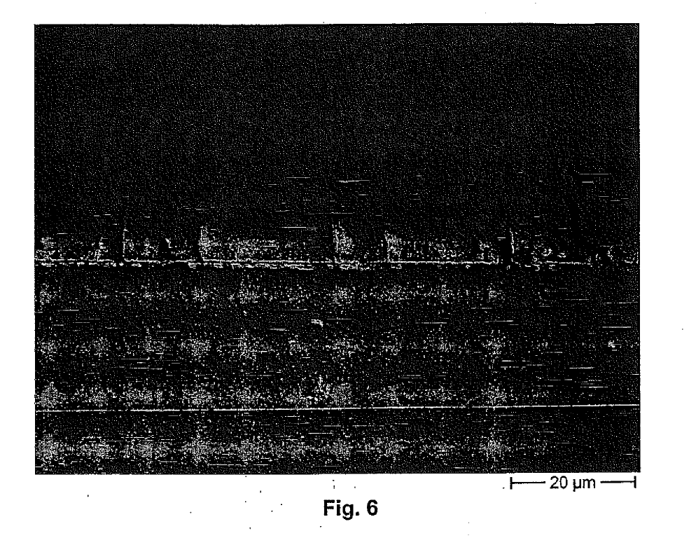

FIG. 7: Sample from urea electrolyte

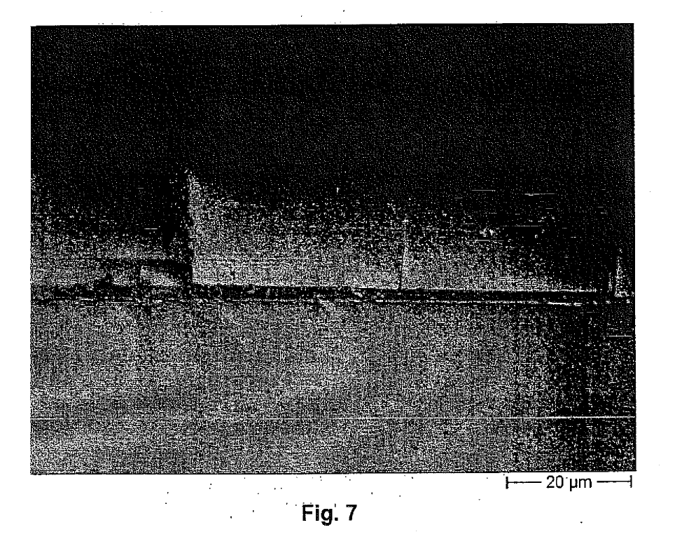

FIG. 8: Sample from alanine electrolyte

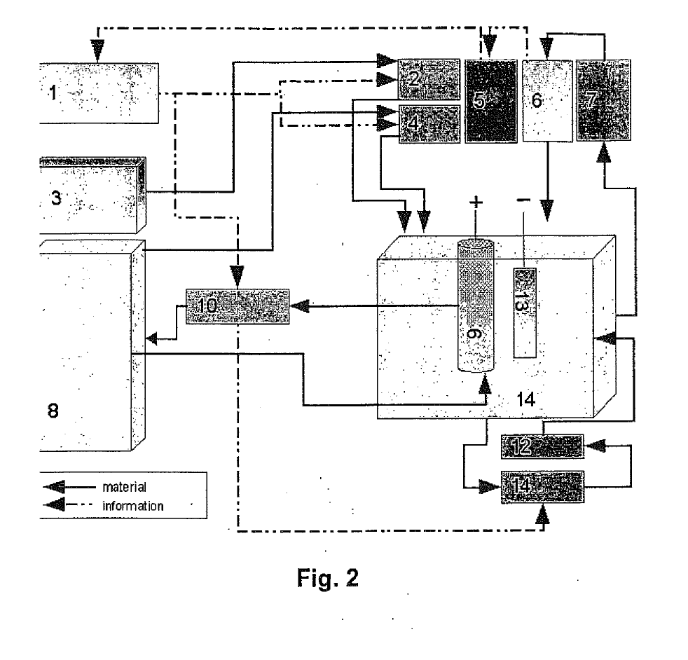

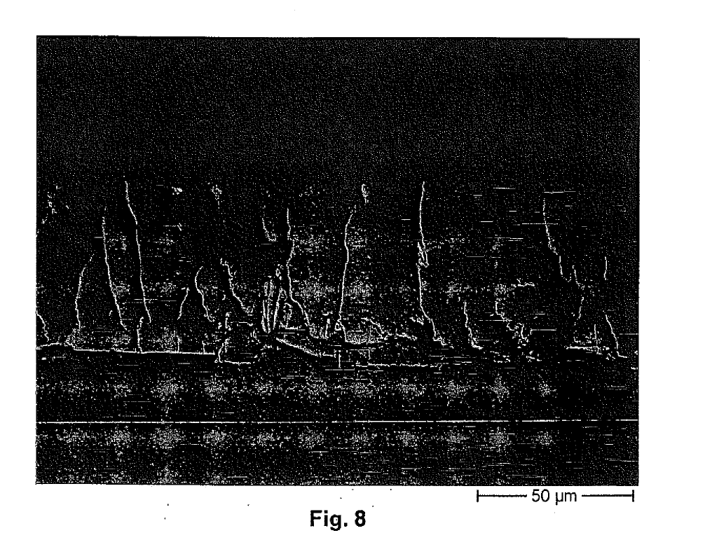

FIG. 2 shows a diagram of the inventive process. A power and control unit 1 monitors the following parameters of the electrolyte and controls the corresponding parts of the plant by sending control signals:
Temperature of the electrolyte
pH of the electrolyte
recirculation of the electrolyte
recirculation of the anolyte
current for electroplating of the part being coated

By using a pump 2 for a base, a base selected from a liquid increasing the pH, e.g. ammonia, is added to the electrolyte in case of a decrease of the pH. This base is kept in a reservoir 3. The pump 2 receives the control signals from the power and control unit 1. By the use of a pump 4 for the acid, a liquid is added to the anolyte decreasing the pH. As a liquid for decreasing the pH, diluted sulphuric acid is preferred. The pump 4 receives the control signals from the power and control unit 1. The pH measuring device 5 amplifies signals from a pH probe in the measuring cell 6 and are relayed to the power and control unit 1. A pump 7 supplies the measuring cell 6 with fresh electrolyte which is taken from the reservoir 14. After finishing the measurement, the electrolyte is recirculated to the reservoir 14. The membrane anode 9 is an anode being encapsulated in an anion-exchanging membrane. The encapsulated anode is inside washed round by diluted sulphuric acid. The sulphuric acid is transported by an anolyte pump 10 from the reservoir 8 to the membrane anode 9. The sulphuric acid runs of by a second orifice of the membrane anode, which serves for the evacuation of the oxygen being generated at the anode. A further electrolyte pump 11 continuously transports electrolyte from the reservoir through a filter unit 12 and in circulation back to the reservoir 14. The part being coated in this process 13 is shown in the middle.

1. Method for deposition of chromium layers as hard-chrome plating for protection against wear or corrosion and/or as decorative chrome plating, in which a part is connected as a cathode and is immersed in a catholyte comprising at least one chromium(III) salt and at least one compound stabilizing chromium(II) ions, an anolyte comprising a Brönsted acid is used, catholyte and anolyte being separated by an anion-selective membrane, and also, by means of at least one measuring device, deviations in the pH value from a predefined pH value are monitored continuously and, by means of at least one control device, the pH value is adjusted to the predefined value by automated addition of an acid or a base.

2. Method according to claim 1, wherein the acid is removed from the anolyte via the control device, said acid being metered subsequently into the catholyte in order to adjust the pH value.

3. Method according to claim 1 wherein the deviation in temperature of the electroplating bath from a predefined value is monitored continuously via a temperature measuring unit and the temperature of the electroplating bath is adjusted to the predefined value via a heating and/or cooling device.

4. Method according to claim 1, wherein the chromium(III) salt is selected from the group consisting of ammonium chromium alum, potassium chromium alum, chromium chloride, chromium sulphate and mixtures thereof.

5. Method according to claim 1, wherein the chromium(III) salt is used in the catholyte in a concentration in the range of 0.1 mol/l up to the solubility limit of the salt.

6. Method according to claim 1, wherein compound stabilizing chromium(II) ions are selected from the group consisting of amino acids, urea, aliphatic, aromatic-aliphatic, cycloaliphatic or aromatic amines and/or amides.

7. Method according to claim 6, wherein the compound stabilizing chromium(II) ions is used in the catholyte in a concentration of 0.5 mol/l to 3 mol/l, preferably 0.5 mol/l to 1.2 mol/l.

8. Method according to claim 1, wherein a buffer substance for buffering the pH value of the catholyte is added to the catholyte.

9. Method according to claim 8, wherein the buffer substance is selected from the group consisting of the systems boric acid/borate, citric acid/citrate, aluminium³⁺/aluminium sulphate, oxalic acid/oxalate and/or tartaric acid/tartrate.

10. Method according to claim 1, wherein a wetting agent is added in addition to the catholyte.

11. Method according to claim 10, wherein the wetting agent is selected from a wetting agent selected preferably from the group consisting of anionic and/or neutral surfactants, such as for example sodium lauryl sulphate, sodium dodecyl sulphate, polyethylene glycols, diisohexylsulphosuccinate, 2-ethylhexylsulphate, diisobutylsulphosuccinate, diisoamylsulphosuccinate and/or isodecylsulphosuccinate.

12. Method according to claim 1, wherein the anolyte contains sulphuric acid.

13. Electroplating bath for deposition of chromium layers as hard-chrome plating for protection against wear or corrosion and/or as decorative chrome plating having a catholyte comprising at least one chromium(III) salt and at least one compound stabilizing chromium(II) ions, an anolyte comprising a protonic acid, catholyte and anolyte being separated by an anion-selective membrane, and also at least one measuring device for continuous monitoring of deviations in the pH value from a predefined pH value and at least one control device for adjusting the pH value to the preset value by automated addition of an acid or a base.

14. Electroplating bath according to claim 13, wherein the control device for removing acid from the anolyte is in contact with the anolyte and, for metering of acid into the catholyte, is in contact with the catholyte.

15. Electroplating bath according to claim 13, wherein the chromium(III) salt is selected from the group consisting of ammonium chromium alum, potassium chromium alum, chromium chloride, chromium sulphate and mixtures thereof.

16. Electroplating bath according to claim 13, wherein the concentration of the at least one chromium(III) salt in the catholyte is in the range of 0.1 mol up to the solubility limit of the salt.

17. Electroplating bath according to claim 13, wherein the compound stabilizing chromium(II) ions is selected from the group consisting of amino acids, urea, aliphatic, cycloaliphatic or aromatic amines and/or amides.

18. Electroplating bath according to claim 17, wherein the compound stabilizing chromium(II) ion is present in the catholyte in a concentration of 0.5 mol/l to 3 mol/l, preferably 0.5 mol/l to 1.2 mol/l.

19. Electroplating bath according to claim 13, wherein the catholyte contains a buffer substance for buffering the pH value of the catholyte.

20. Electroplating bath according to claim 19, wherein the buffer substance is selected from the group consisting of the systems boric acid/borate, citric acid/citrate, tartaric acid/tartrate, aluminium/aluminium sulphate.

21. Electroplating bath according to claim 13, wherein the catholyte contains in addition a wetting agent.

22. Electroplating bath according to claim 21, wherein the wetting agent is selected from anionic and/or neutral surfactants, such as for example sodium lauryl sulphate, sodium dodecyl sulphate, polyethylene glycols, diisohexylsulphosuccinate, 2-ethylhexylsulphate, diisobutylsulphosuccinate, diisoamylsulphosuccinate and/or isodecylsulphosuccinate.

23. Electroplating bath according to claim 13, wherein the anolyte contains sulphuric acid.

24. Electroplating bath according to claim 13, wherein the electroplating bath has a dimensionally stable anode (DSA).

25. Electroplating bath according to claim 24, wherein the dimensionally stable anode (DSA) is selected from the group consisting of graphite or anodes comprising a lead alloy, anodes coated with a mixed oxide and/or platinised anodes.

26. Hard-chrome surface which can be produced according to the method according to claim 1.

27. Hard-chrome surface according to claim 26, the thickness of the chromium layer being at least 5 μm and the part surface having a Vickers hardness according to EN ISO 6507 of at least 800 HV.

28. Hard-chrome surface according to claim 26, wherein the thickness of the chromium layer is at least 10 μm.

29. Surface according to claim 26, wherein the surface serves for decorative purposes and has the layer thickness <5 μm.
